(19) United States
(12) Patent Application Publication
(10) Pub. No.: US 2013/0249256 A1
(43) Pub. Date: Sep. 26, 2013

(54) CHAIR

(71) Applicants: Don Payne, JR., Greeneville, TN (US); Linda West Schumann, Jefferson City, TN (US); Kenneth C. Peacock, Morristown, TN (US); Steven Ralph McNay, Seymour, TN (US)

(72) Inventors: Don Payne, JR., Greeneville, TN (US); Linda West Schumann, Jefferson City, TN (US); Kenneth C. Peacock, Morristown, TN (US); Steven Ralph McNay, Seymour, TN (US)

(73) Assignee: Meco Corporation, Greeneville, TN (US)

(21) Appl. No.: 13/427,722

(22) Filed: Mar. 22, 2012

(51) Int. Cl. A47B 83/02; B23P 17/00; A47C 7/62

(52) U.S. Cl. 297/161; 297/188.14; 297/160; 297/188.19; 29/428

(57) ABSTRACT

A chair, such as, e.g., an easy chair or, a recliner, may include a compartment, a tray, or both. The compartment may have an open position and a closed position and may include a panel configured for a specific purpose. For example, the panel may include a cup holder, a storage slot, and an outlet. The outlet may include a power outlet, a USB port, an ethernet port, or the like. The tray may rotate about a shaft and/or an arm of the chair so that does not pose a nuisance to a user of the chair. The tray may include a mechanism to slide the tray between a first position and a second position.

### BACKGROUND OF THE PRESENT DISCLOSURE

1. Field of the Present Disclosure

The present disclosure is directed to a chair and a method of assembling a chair, which may include a compartment and/or a tray.

2. Related Art

Many chairs, including easy chairs, recliners, and the like, have not changed substantially in design or function for decades. This is due in part to the comfort and satisfaction that these designs continue to provide to modem users. Modern life, however, has changed dramatically from what it was thirty years ago. A typical working adult of that era had access to only a handful of broadcast television channels, received a daily newspaper, and used telephones that connected to the wall.

In contrast, a modern working adult is constantly connected. She may use a smartphone to stay in touch with friends and coworkers via email, text messaging, blogs, and social networking. She may use a laptop to work from home, a coffeeshop, an airport, or any other location that offers an Internet connection. She may have access to hundreds of cable television channels, mail-order MID rentals, programs recorded on her DVR, and online streaming movies and television shows.

Despite all of these conveniences, modern life is just as stressful as it was in past eras, if not more so. Therefore, a modem working adult may seek the relaxation of a comfortable chair just as much as her predecessor, but at the same time, the modern adult may want or need to stay connected. Many current chairs, which may have been designed in previous eras or derived from such designs, may be suboptimal for multitasking in this manner. For example, current chairs may not provide a convenient or accessible place to store or use a laptop or tablet computer. Many current chairs may also fail to provide options for powering modern devices, storing such devices, or retaining food and/or beverage containers.

Accordingly, there is a need for a comfortable chair, such as, e.g., an easy chair or a recliner, that is comfortable and relaxing while simultaneously providing support for the demands of modern life.

### SUMMARY OF THE PRESENT DISCLOSURE

The present disclosure meets the foregoing need and allows a chair to provide a work surface, power options, and/or container retention, which results in a significant increase in convenience and other advantages apparent from the discussion herein.

Additional features, advantages, and aspects of the present disclosure may be set forth or apparent from consideration of the following detailed description, drawings, and claims. Moreover, it is to be understood that both the foregoing summary of the present disclosure and the following detailed description are exemplary and intended to provide further explanation without limiting the scope of the present disclosure as claimed.

### BRIEF DESCRIPTION OF THE DRAWINGS

The accompanying drawings, which are included to provide a further understanding of the present disclosure, are incorporated in and constitute a part of this specification, illustrate aspects of the present disclosure and together with the detailed description serve to explain the principles of the present disclosure. No attempt is made to show structural details of the present disclosure in more detail than may be necessary for a fundamental understanding of the present disclosure and the various ways in which it may be practiced. In the drawings:

FIG. 1 shows a perspective view of a chair, according to an aspect of the present disclosure;

FIG. 2 shows the chair from the front;

FIG. 3 shows the chair from the left side;

FIG. 4 shows a perspective view of the chair with the compartment in an open position;

FIG. 5 shows the chair from the front with the compartment in an open or deployed position; and

FIG. 6 shows the chair from the left side with the compartment in an open or deployed Position.

### DETAILED DESCRIPTION OF THE PRESENT DISCLOSURE

The aspects of the present disclosure and the various features and advantageous details thereof are explained more fully with reference to the non-limiting aspects and examples that are described and/or illustrated in the accompanying drawings and detailed in the following description. It should be noted that the features illustrated in the drawings are not necessarily drawn to scale, and features of one aspect may be employed with other aspects as the skilled artisan would recognize, even if not explicitly stated herein. Descriptions of well-known components and processing techniques may be omitted so as to not unnecessarily obscure the aspects of the present disclosure. The examples used herein are intended merely to facilitate an understanding of ways in which the present disclosure may be practiced and to further enable those of skill in the art to practice the aspects of the present disclosure. Accordingly, the examples and aspects herein should not be construed as limiting the scope of the present disclosure, which is defined solely by the appended claims and applicable law. Moreover, it is noted that like reference numerals represent similar parts throughout the several views of the drawings.

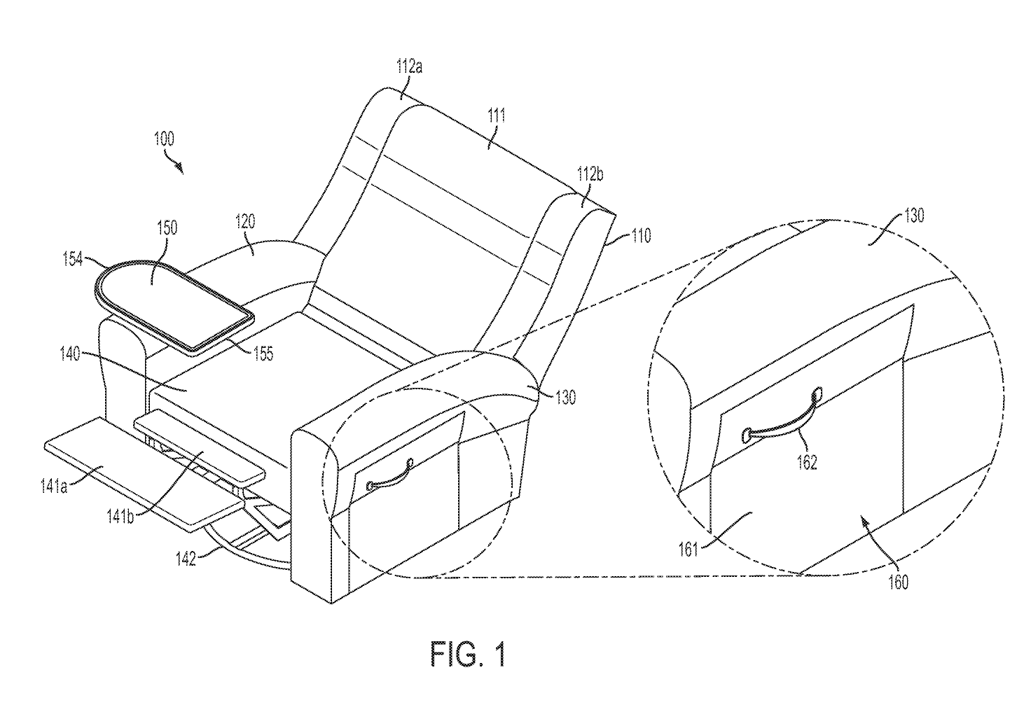

FIG. 1 shows a perspective view of a chair 100, according to an aspect of the present disclosure. The chair 100 may be an armchair, a recliner, a sofa, or the like, and it may include an upright position and a reclined position. The chair 100 may include a back 110, a right arm 120, a left arm 130, and a seat 140. The chair may further include a tray 150 and/or a storage compartment 160.

The back 110 may include a center portion 111, a right side portion 112a, and a left side portion 112b. The back 110 may recline from an up-right position. The back 110 may have multiple reclining positions such that a user may be able to adjust the angle of the back for maximum comfort and convenience in varying circumstances, e.g., reading, typing, napping, watching television, and the like. In addition, different users may have different preferences for the angle of the back 110, so the use of multiple positions allows the chair 100 to accommodate the varying tastes of different users, e.g., in a family.

As shown in the inset in FIG. 1, the chair 100 may include a compartment 160 set into the left arm 130. The compartment 160 may have a door or panel 161 and may be accessible by a handle 162. The handle 162 may be centered on the door 161 for a more pleasing appearance, or the handle 162 may be off-center, as shown in FIG. 1. The off-center handle 162 may be more accessible to a user of the chair 100 or easier for a user to reach and/or open without straining or the need to get up from the chair 100.

In addition to, or instead of the handle 162, the door or panel 161 may be opened/closed by a recess (not shown) that may be grasped by a hand and pulled in a direction that is substantially perpendicular to the planar surface of the door or panel 161. Further, the door or panel 161 may be automated and configured to open/close in response to an electronic actuator (not shown) that may provided in the chair or a remote control device not shown) that communicates with the chair via a communication link.

The door 161 may be connected to the arm 130 along the lower edge of the door 161, or along a side edge of the door 161 (not shown). The connection may allow the door 161 to pivot about the connection and may include a hinge, a pivot, a pin, a gear, a rotor, or the like. The connection may limit the range of motion of the door 161 and the compartment 160. For example, the connection may restrict or define the maximum angle between the door 161 in an open position and the arm 130. The chair 100 may utilize a latch or other mechanism to retain the door 161 in a closed position. A latch used for this purpose may include a magnetic latch, a touch latch, a bullet catch, a gate latch, a push catch, a ball catch, a double ball catch, or the like.

Alternative means of opening and/or closing the compartment 160 are contemplated and within the spirit and scope of the disclosure. For example, the compartment 160 may use a touch latch (not shown) in place of the handle 162. With a touch latch, the user may press on the panel 161 and depress it slightly, which may cause the latch to extend the panel 161 so that it is now open, e.g., about 1 inch or so. The user may press on an internal part of the compartment 160 to disengage it from the latch and fully open the compartment 160. To close the compartment 160, the user may lift the panel 161 until the latch is engaged. The user may then press the panel 161 until it is slightly depressed relative to the side of the chair 100. Upon release, the latch may retain the compartment 160 so that the panel 161 is substantially flush with the side of the chair 100.

The front of the chair 100 may include one or more panels that may function as footrests 141a, 141b when the chair 100 is reclined. When the chair 100 is in an upright position, the panels 141a, 141b may form the front of the chair 100. When the chair 100 is positioned in a reclined position, the panels 141a, 141b may extend to become footrests, as seen in FIG. 1. The chair 100 may convert between an upright position and a reclined position by the use of a handle on the side of the chair 100, or through an automated mechanism, such as, e.g., an electric motor, or the like. Traditionally, such a handle may be located on the right side 120 of the chair 100. This location is convenient for the present disclosure, as it will not interfere with the compartment 160. If, however, it is desirable to place the lever on the left side 130 of the chair 100, it will be apparent to one skilled in the art how to move the compartment from the left side 130 to the right side 120. Such a change may be effected without departing from the present disclosure. As an alternative to the handle, the chair 100 may convert from an upright position to a reclined position when a user sits in the chair and presses backwards with her torso. This user-generated force may cause the back 110 to recline and the footrests 141a, 141b to extend.

Alternatively, the compartment 160 and door or panel 161 may be provided in both the right side 120 and the left side 130. Additionally, the compartment 160 and door or panel 161 may be provided in the front portion of the right side 120 and/or left side 130. In this regard, since the front portions of the right side 120 and left side 130 may have smaller cross-sectional area, the compartment 160 and panel 161 may be configured accordingly and implemented, e.g., to hold a telephone, an iPod, a television remote control, and the like.

The chair 100 may be configured to have one or more positions, ranging from a single upright position to a plurality of positions that include the upright position and a reclined position, as well as additional positions between the upright position and the reclined position.

The chair 100 may include a stand or base 142. The base 142 may be connected to the internal frame (not shown) of the chair 100. The base 142 may also support, directly or indirectly, the mechanisms of the chair 100 that enable, e.g., the reclining back 110, the extension of the footrests 141a, 141b, and the like. The base 142 may allow the chair to swivel or rotate in a lateral or sideways direction, rotate about an axis that is perpendicular to the floor. The base 142 may additionally or alternatively include a rocking mechanism to allow a user to gently sway the chair 100 from front to back. The chair 100 may further include mechanisms to restrict or retard one or more of these motions. For example, the user may be able to engage a mechanism to prevent the chair 100 from rocking, instead fixing it in a particular position.

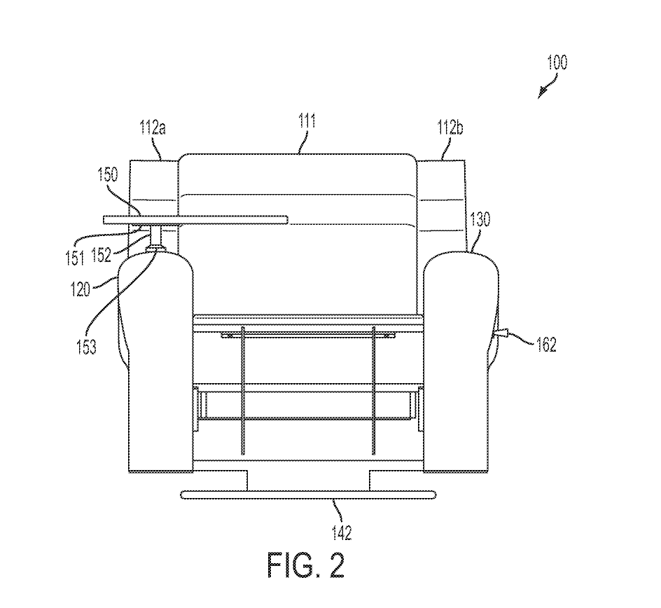

FIG. 2 shows the chair 100 from the front. The center portion 111 may have a different height than the side portions 112a, 112b. As seen in FIG. 2, the center portion 111 may be higher than the side portions 112a, 112b, or the center portion 111 may be lower than the side portions 112a, 112b. The height of the center portion 111, especially in comparison to the side portions 112a, 112b, may be controlled by the construction of the back 110, including, e.g., sewing, stitching, gluing, welding, stuffing, padding, cushioning, or the like. The internal frame of the back 110 may also affect the relative height of the center portion 111 in comparison to the side portions 112a, 112b.

A tray 150 may be located on or attached to the right arm 120. The tray 150 may be substantially flat or planar in appearance and/or construction. As seen in FIG. 1, the tray 150 may be substantially rectangular in appearance and/or construction, having a longer axis or dimension and a shorter axis or dimension. The tray 150 may have a pair of shorter sides and a pair of longer sides. The shorter sides and the longer sides may alternate around the edge of the tray 150. The longer axis may be oriented substantially parallel to one or both of the longer sides, and the shorter axis may be oriented substantially parallel to one or both of the shorter sides. One of the shorter sides may be rounded 154 and one of shorter sides may be square 155. The rounded side 154 may be oriented or located farther away from the seat 140, and the square side 155 may be oriented or located closer to the seat 140.

The tray 150 may be connected to the arm. 120 by one or more of a mechanism 151, a shaft 152, and a base 153. One or more of the mechanism 151, the shaft 152, and the base may provide the ability to adjust the distance between, e.g., the tray 150 and the seat 140. For example, the shaft may include one or more telescoping sections. The shaft 152 or the base 153 may include a mechanism to lock or retain the tray 150 once the user has set it to a specific height. As an additional example, the shaft 152 may pass through the base 153 into the interior of the arm 120. The base 153 may include a locking mechanism that may selectively engage the shaft 152. For example, a user may cause the base 153 to engage the shaft 152 by twisting the base 153 in one direction, and disengage the shaft 152 by twisting in the opposite direction. Since the shaft 152 passes through the base 153, the user may be able to slide or move the shaft 152 relative to the base 153 when the base 153 is disengaged. The user may then be able to lock the shaft 152 to a specific position by twisting the base 153 to engage the shaft 152. Moving the shaft 152 relative to the base 153 in this manner may allow the user to adjust the distance between the tray 150 and the seat 140, i.e. the height of the tray 150.

The connection between the tray 150 and the arm 120 may be centered on the tray, or it may be located off-center, as seen in FIG. 2. For example, the shaft 152 may be centered front-to-back and/or left-to-right on the tray 150. Similarly, the shaft may be centered front-to-back but off-center left-to-right. Other arrangements and combinations are possible, as will be appreciated by those skilled in the art. An off-center connection may orient the tray 150 such that it may partially project or extend above the seat 140. The mechanism 151 may allow the tray 150 to slide from the partially extended position shown in FIG. 2 to a position that is more directly above the seat 140. In this second position, the top of the tray may be more conveniently located for a user sitting in the chair. For example, the user of the chair may find it easier and/or less messy to eat food from the tray when it is more centered above the seat 140. Similarly, a user may find it easier or more convenient to use, e.g., a laptop or table-style computer placed on the tray 150 when the tray is more centered above the seat 140.

A user entering or exiting the chair 100 may find that the tray 150, even in the partially extended position as shown in, e.g., FIG. 2, poses a nuisance, hazard, or obstacle. To alleviate this problem, the tray 150 may rely on one or more of the mechanism 151, the shaft 152, and the base 153 to rotate about the shaft 152. For example, the tray 150 may partially project or extend over the seat 140. After rotating approximately 90° about the shaft 152, the tray 150 may no longer extend or project above the seat 140. In this rotated position, the tray 150 may be substantially or completely above the right arm 120. This orientation may make it easier for a user to enter or exit the chair 100.

The tray may also be capable of rotating about the shaft 152 by an additional 90° degrees or so, such that it may be approximately 180° from the starting position seen, e.g., in FIG. 2. In this position, the rounded side 154 of the tray 150 may be closer to the seat 140, and the square side may be farther from the seat 140. With the tray 150 in this orientation, it may be even easier for a user to enter or exit the chair 100. The tray 150 may be capable of rotating about the shaft 152 by approximately 270° or by approximately 360°. The tray 150 may also include one or more notches or stops such that the tray is easy to align at certain indexed positions or orientations. For example, a tray 150 that rotates approximately 360° may include stops approximately every 90° so that it is easy for a user to orient the square end 155 of the tray 150, e.g., above the seat 140, along the arm 120, or directly away from the seat 140. As a further example, a tray that rotates through approximately 90° may include a stop or notch at both ends of its range of motion. While the stops in this example are not necessary to orient the tray 150 in a particular direction, the stops may act to retain the tray 150 in a particular orientation.

The right arm 120 may include a track, rail, slide, or other mechanism to allow the tray 150 to rotate about the arm 120 itself. For example, the tray 150 as shown in FIG. 2 has a substantially horizontal orientation. After rotating about the arm 120, the tray 150 may have a substantially vertical orientation. Rotating about the arm 120 may be used as an alternative to the rotating mechanism, described above, or the two may be used together. If the two are used together, one or more locking mechanisms may be implemented. One locking mechanism may prevent the tray 150 from rotating about the arm 120 without first disengaging the mechanism. A second locking mechanism may prevent the tray 150 from rotating about the shaft 152 without disengaging the mechanism. A third locking mechanism may engage the mechanism 151 for sliding the tray. The third locking mechanism may prevent the tray from sliding, e.g., when the tray is in a substantially vertical orientation. The use of one or more locking mechanisms may prevent or reduce accidents associated with the tray 150 rotating about one or both of the arm 120 and the shaft 152 at an unwanted or unintended time.

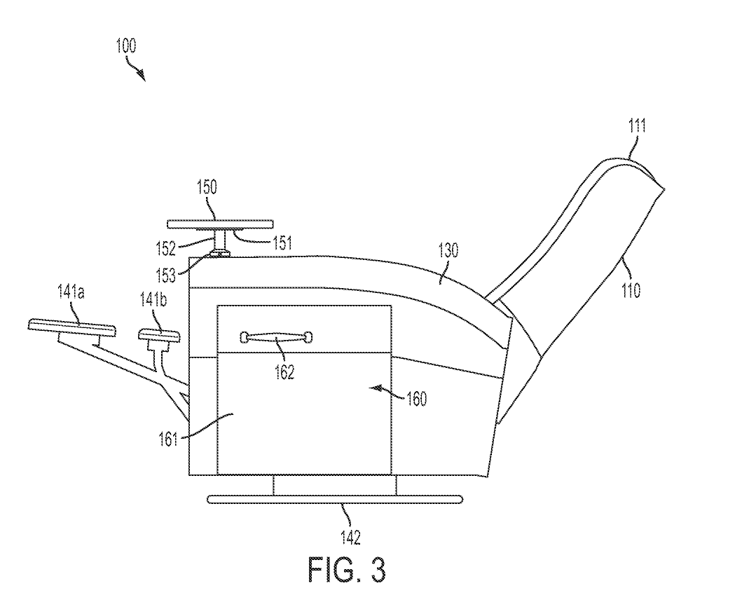

FIG. 3 shows the chair 100 from the left side. A compartment 160 may be located in the left arm 130. The compartment 160 may be centered in the arm 130, or it may be off-center, as seen, e.g., in FIG. 3. A handle 162 may be centered on the door 161 to the compartment 160, or the handle may be off-center, as seen, e.g., in FIG. 3. The off-center location of the compartment 160 and/or the handle 162 may be easier or more comfortable for a user of the chair 100 to open the compartment 160 while sitting in the chair 100.

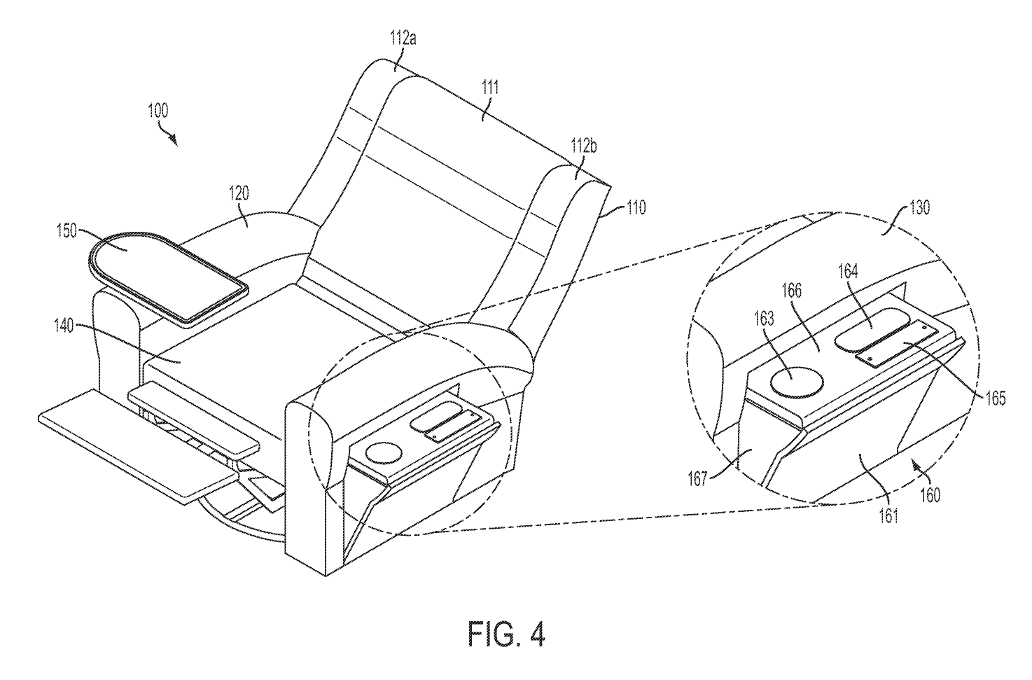

FIG. 4 shows a perspective view of the chair 100 with the compartment 160 in an open position. FIG. 4 is substantially identical to FIG. 1 except that the compartment 160 is in an open position. The compartment may include a top panel 166. The configuration of the compartment 160 and the panel 166, an example of which is shown in the inset to FIG. 4, may vary depending on, e.g., the specific market of the chair 100, the intended end user of the chair 100, availability of source materials, and the like. For example, the panel 166 may include a cup holder 163. The cup holder 163 may simply be a cut out in the panel 166 with a hollow underneath. This type of cup holder 163 may be restricted to holding or retaining containers that are narrow enough at the bottom to enter the cup holder 163 but wide enough at the top that they do not pass entirety through it. Alternatively, the cup holder 163 may include a bottom that may prevent smaller containers from passing entirely through the cup holder. This type of cup holder 163 may be able to accommodate a larger variety of container shapes and sizes. For example, a cylindrical container, such as a soda can, may not be retained by the first, bottomless cup holder but may be held by the second type. The panel 166 may also include a cutout or slot 164. Slot 164 may include sides and a bottom and may be suitable for holding items such as, e.g., magazines, remote controls, snack bags or other food items, and the like. The panel 166 may further include an outlet 165, which may include, for example, a power outlet, a universal serial bus (USB) port, a USB hub, an ethernet port, an RJ45 socket, and the like, or any combination thereof. One or more of the chair 100, the panel 160, and the outlet 165 may offer, e.g., Bluetooth connectivity or functionality, WiFi connectivity or functionality, personal-area network connectivity or functionality, or the like, via one or more communication links. For a chair 100 that offers a specific type of connection or connector in its compartment 160 and/or outlet 165, the chair 100 itself may include one or more cables that may connect to a corresponding outlet in the building or surrounding structure. By connecting to, e.g., a building source, the chair 100 may be able to offer one or more active or live connections to the user via the panel 166 and/or the outlet 165.

Alternative arrangements of the panel 166 and the compartment 160 are contemplated and are within the scope and spirit of the present disclosure. For example, the compartment 160 may be configured to act as a storage area for a book, a magazine, or other printed publications. For this configuration of the compartment 160, the panel 166 may have a single slot that occupies most of its face or area. Alternatively, the panel 166 may be omitted entirely. As a further example, the compartment 160 may be configured to store a device, such as a laptop computer, a notebook computer, a tablet computer, a smartphone, or the like. Again, the panel 166 my have a single slot (or multiple slots) that occupies most of its face or area or may be omitted entirely. The interior of the compartment 160 may include a lining or padding to protect a device from bumps, jostling, and damage when the compartment 160 is opened and/or closed. The compartment 160 may alternatively or additionally include a support (such as, e.g., a strap, an elastic band, or the like) for securing a device in the compartment 160 and substantially or largely protecting it from damage. The support may include a snap buckle, a snap closure, a button closure, a hoop-and-loop fastener (e.g., Velcro®), or the like.

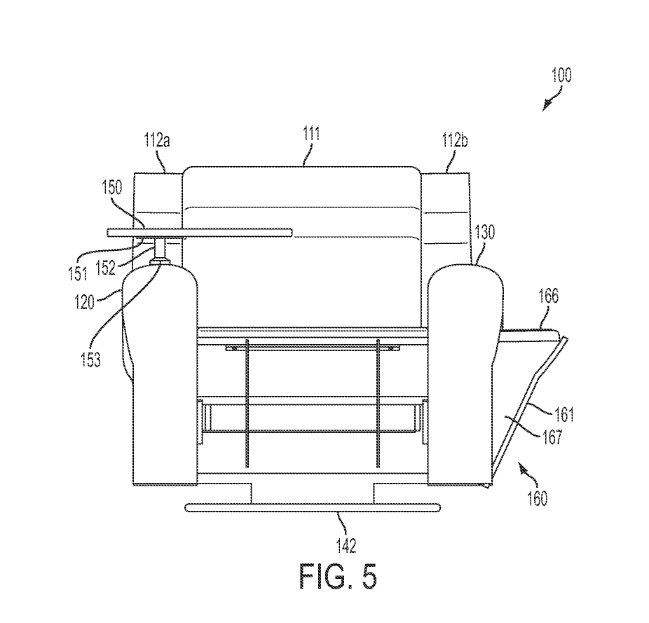

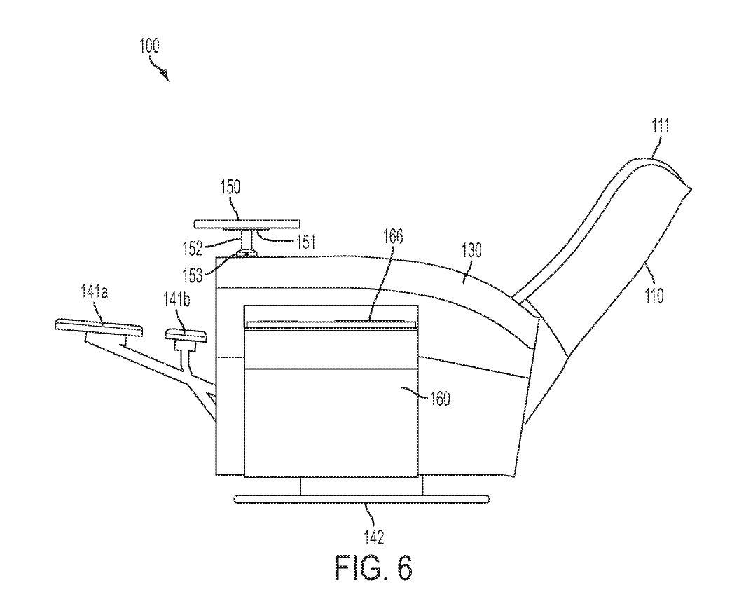

FIG. 5 shows the chair 100 from the front with the compartment 160 in an open or deployed (or reclined) position, and FIG. 6 shows the chair 100 from the left side with the compartment 160 in an open or deployed position. With the compartment 160 in an open position, the panel 166 may be largely, substantially, or completely horizontal. By placing the panel 166 in a horizontal or almost horizontal orientation, the features of the panel, such as, e.g., a cup holder 163, slot 164, or outlet 165, a user of the chair 100 may find the features to be more convenient, more ergonomic, or the like.

The compartment 160 may include a side cover 167. The compartment 160 may have one or more side covers 167. For example, a side cover 167 may be visible from the front of the chair 100, as seen in FIG. 5. A side cover 167 may be visible from the back or rear of the chair. The side cover 167 may be joined to the door 161 and the panel 166 to enclose a defined space for the compartment 160. By using one or more side covers 167, the compartment 160 may present a cleaner or more aesthetically pleasing appearance while in an open position. For example, any portion of the cup holder 163 that extends below the panel 166 may be hidden from view by the side cover 167.

As the panel 161 may be connected to the chair 100 by a pivoting connection, the compartment 160 may be moved between an open position and a closed position, e.g., by rotating about the pivoting connection. Components of the compartment 160, such as, e.g., the panel 166 and the side cover 167, may be connected to the door 161 with a rigid or immobile construction. The components may be attached to the door 161 with, e.g., a screw, a nail, a rivet, a bolt, an adhesive (e.g., a tack glue, an epoxy, or the like), or the like. The chair 100 may include a recess in the left arm 130 to accommodate the rigid components of the compartment 160. This type of construction may be particularly compatible with aspects of the compartment 160 that may be intended to store items when the compartment 160 is in a closed position.

Alternatively, the components of the compartment 160 may be pivotally or rotatably affixed to the door 161, the arm 130, or both. The pivotal connections may include, e.g., a hinge, a pin, a rotor, and the like. When the door 161 is moved from an open position to a closed position, the components, such as, e.g., the panel 166 and the side cover 167, may rotate about these pivotal connections. By rotating, the components may fold into a more compact orientation for storage within the arm 130 of the chair 100. For example, the panel 166 may fold so that it is substantially flush against the internal face of the door 161 when the door 161 is in a closed position. The chair 100 may include a shallow recess in the left arm 130 for receiving or accommodating the components of the compartment 160 in a collapsed or folded orientation. This type of construction may be suited primarily or exclusively for aspects of the compartment 160 that are not intended to store items when the compartment 160 is in a closed position.

A chair 100 according to the present disclosure may be made from any suitable material or combination of materials, including, for example, wood, plywood, medium density fiberboard, metal, steel, aluminum, fabric, nylon, cotton, leather, vinyl, foam rubber, and the like. A chair 100 may be manufactured by providing the necessary components, such as, e.g., a back 110, a seat 140, at least one arm 130, and a compartment 160. The back 110, the seat 140, and the arm 130 may then be assembled to form the chair 100, and the compartment 160 may be disposed within the arm 130. An additional arm 120 may also be provided and attached to the chair 100. A tray 150 may be attached to the additional arm 120 and may include a shaft and/or a mechanism connecting it to the arm 120. The tray 150 may be configured to rotate about the arm 120, about the shaft 152, or both. The compartment 160 may include a panel 161 that may have a cup holder 163, slot 164, and/or an outlet 165. The specifics of the manufacturing process will vary depending on the desired features and materials used, and the specifics will be apparent to those skilled in the art of chair design and manufacture.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, the Internet, or the like, or any combination of the foregoing, any of which may be configured to communicate data via a wireless and/or a wired communication medium. These networks may run a variety of protocols not limited to TCP/IP, IRC or HTTP.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, or the like, may be described in a sequential order, such processes and methods may be configured to work in alternate orders. In other words, any sequence or order of steps that may be described does not necessarily indicate a requirement that the steps be performed in that order. The steps of the processes or methods described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

While the present disclosure has been described in terms of exemplary aspects, those skilled in the art will recognize that the present disclosure can be practiced with modifications in the spirit and scope of the appended claims. These examples given above are merely illustrative and are not meant to be an exhaustive list of all possible designs, aspects, applications or modifications of the present disclosure.

What is claimed is:

1. A chair comprising:
a back;
a first arm;
a seat; and
a compartment disposed within the first arm, the compartment having a closed position and an open position.

2. The chair of claim 1, further comprising:
a second arm; and
a tray connected to the second arm.

3. The chair of claim 2, wherein the tray is configured to rotate about the second arm between a third position and a fourth position.

4. The chair of claim 2, further comprising a shaft connecting the tray to the second arm.

5. The chair of claim 4, further comprising a mechanism disposed between the shaft and the tray, the mechanism configured to slide the tray between a first position and a second position.

6. The chair of claim 4, wherein the tray is configured to rotate about the shaft.

7. The chair of claim 1, wherein the compartment comprises:
a door that is substantially flush with a side of the first arm when the compartment is in a closed position; and
a panel configured to be disposed between the door and the side of the first arm when the compartment is in an open position.

8. The chair of claim 7, wherein the compartment comprises a side cover configured to form a side of the compartment when the compartment is in an open position.

9. The chair of claim 7, wherein the panel comprises a cup holder.

10. The chair of claim 9, wherein the panel comprises a slot and an outlet.

11. The chair of claim 10, wherein the outlet comprises at least one of a power outlet, a universal serial bus port, a universal serial bus hub, an ethernet port, and an RJ45 socket.

12. A method of manufacturing a chair, the method comprising:
providing a back;
providing a first arm;
providing a seat;
assembling the back, the first arm, and the seat to form a chair; and
disposing a compartment within the first arm, the compartment configured to move between an open position and a closed position.

13. The method of claim 12, further comprising:
providing a second arm;
providing a tray;
attaching the second arm to the chair; and
connecting a tray to the second arm.

14. The method of claim 13, wherein connecting the tray to the second arm comprises:
providing a shaft;
connecting the tray to the shaft; and
connect the shaft to the second arm.

15. The method of claim 14, wherein connecting the tray to the shaft comprises:
providing a mechanism;
connecting the tray to the mechanism; and
connecting the mechanism to the shaft, the mechanism configured to slide the tray between a first position and a second position.

16. The method of claim 13, wherein the tray is configured to rotate about the shaft.

17. The method of claim 12, wherein disposing the compartment comprises:
providing a door;
providing a panel;
connecting the door to the first arm such that the door is configured to be substantially flush with a side of the arm when the compartment is in a closed position; and
connecting the panel to at least one of the door and the first arm such that the panel is configured to be disposed between the door and the side of the first arm when the compartment is in an open position.

18. The method of claim 17, wherein the panel comprises a cup holder.

19. The method of claim 18, wherein the panel comprises a slot and an outlet.

20. The method of claim 19, wherein the outlet comprises at least one of a power outlet, a universal serial bus port, a universal serial bus hub, an ethernet port, and an RJ45 socket.
